(19) United States
(12) Patent Application Publication
(10) Pub. No.: US 2009/0189852 A1
(43) Pub. Date: Jul. 30, 2009

(54) INDEX WHEEL HAVING NOTATIONS AND METHOD OF MANUFACTURE THEREOF

(76) Inventor: Chin-Wen CHOU, Taipei Hsien (TW)

Correspondence Address: Joe McKinney Muncy, PO Box 1364, Fairfax, VA, 22038-1364, US

(21) Appl. No.: 12/020,433

(22) Filed: Jan. 25, 2008

(51) Int. Cl. G09G 5/00; B28B 1/00

(52) U.S. Cl. 345/156; 264/642

(57) ABSTRACT

An index wheel having notations adopted on an electronic device to be freely rotated to generate signal command output includes at least an inner axis layer and an operation layer encasing the inner axis layer in a coaxial manner and movable together at the same time. The operation layer is made from a ceramic material and formed integrally by molding and sintering. The operation layer also has a graphic notation zone on the surface that contains desired graphics or texts. Thus the profile of the index wheel is more versatile and provides a greater appeal to users.

### FIELD OF THE INVENTION

The present invention relates to an index wheel to control command output of electronic devices and particularly to an index wheel that has notations formed thereon.

### BACKGROUND OF THE INVENTION

A conventional electronic equipment such as a personal computer or industrial computer usually has an input device to control cursor locations on a display device, such as a keyboard, joystick or mouse. The mouse has a greater maneuverability and is adaptable to various types of input devices, and can be moved easily in desired directions to generate a signal according to a corresponding position to control cursor location. The present mouse, aside from having at least two function keys, also has a roller between the two function keys. Reference can be found in U.S. Pat. Nos. 6,700,564 and 6,188,389 and the like. The roller thus formed allows users to scroll quickly displaying pictures during browsing a great amount of data or maneuver the cursor without moving the mouse.

The technology of mouse is well developed in electronic industry. The present trend mainly aims to provide more powerful function and more ergonomic design to facilitate operation. The external design also is an important factor to appeal users. The conventional roller generally is made from silicon or plastics. The facilitate fabrication, it is mostly formed in a single color, and also made integrally by injection. Hence there is no much selection on color or profiles.

In order to make the mouse roller more versatile, some techniques have been developed. For instance, R.O.C. patent No. M256979 discloses a mouse with a dual-color roller. Its roller has a left side, a right side and a middle portion each is made from a transparent or opaque material. There is a light emitting diode located beneath the roller to emit light to allow the roller to present different colors. R.O.C. patent publication No. 470910 and patent No. M241750 also disclose a technique which provide a light source to project a transparent roller unit to form a luminous roller. While those rollers on the mouse can alter the appearance thereof through elements that emit light or are formed with different colors, they are limited to color alteration without forming graphics or texts thereon. Hence they are still look dull and plain, and do not have much appeal to whet consumers' purchasing desire.

### SUMMARY OF THE INVENTION

The primary object of the present invention is to provide a roller in an input device that is more versatile by having color selection and graphics to suit user's requirements and preference. To achieve the foregoing object the invention provides an index wheel that has notations formed thereon, and is installed on an electronic device and freely rotatable to generate signal command output. The index wheel has at least one inner axis layer and an operation layer encasing the inner axis layer in a coaxial manner that are movable together at the same time. The operation layer is made from a ceramic material and formed integrally by molding and sintering. The operation layer also has a graphic notation zone on the surface thereof.

The present invention also provides a method to manufacture the index wheel formed with notations set forth above. The method includes procedures as follow:
a. measure for fabricating an inner axis layer;
b. measure for fabricating an operation layer: forming the operation layer on an outer side of the inner axis layer by integrated molding and sintering; and
c. measure for forming a graphic notation zone on the surface of the operation layer.

The graphic notation zone can be selectively formed on the surface of the operation layer by glazing, printing graphics or texts or laser engraving. Compared with the conventional roller, the index roller of the invention, aside from glazing the graphic notation zone on the ceramic material to add color alteration, also can form desired graphics or texts on the graphic notation zone to make the profile of the index wheel more versatile and appealing to suit user's requirements and preference.

The foregoing, as well as additional objects, features and advantages of the invention will be more readily apparent from the following detailed description, which proceeds with reference to the accompanying drawings.

### BRIEF DESCRIPTION OF THE DRAWINGS

FIG. 1 is a perspective view of an embodiment of the index wheel having notations according to the invention.

FIG. 2 is an exploded view of an embodiment of the index wheel having notations according to the invention.

FIG. 3 is a flow chart of an embodiment of the method for manufacturing the index wheel of the invention

FIG. 4 is a perspective view of an embodiment of the index wheel of the invention adopted on a roller module.

FIG. 5 is an exploded view of an embodiment of the index wheel of the invention adopted on a roller module.

### DETAILED DESCRIPTION OF THE PREFERRED EMBODIMENTS

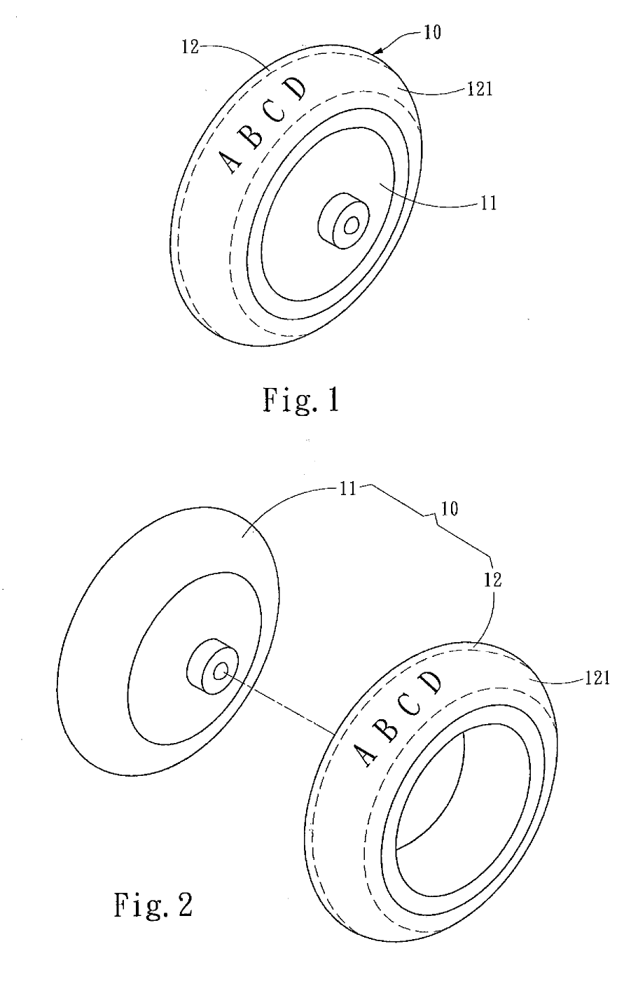

Please refer to FIGS. 1 and 2 for an embodiment of the index wheel having notations of the invention. The index wheel 10 is installed on an electronic device to be freely rotated to generate signal command output. The electronic device may be a keyboard, mouse, joystick or the like. The types of the electronic device mentioned above serve only as an embodiment reference, but not the limitation of the invention. The index wheel 10 has an inner axis layer 11 and an operation layer 12 encasing the inner axis layer 11 in a coaxial manner to be moved together at the same time. The operation layer 12 is made from a ceramic material by integrated molding and sintering. The operation layer 12 also has a graphic notation zone 121 on the surface. The ceramic material for forming the operation layer 12 may be selected from the group consisting of oxides, carbides, boronic compounds, nitrides and combinations thereof. The oxides may be selected from the group consisting of Al₂O₃, SiO₂, ZrO₂, TiO₂ and combinations thereof. Moreover, the operation layer 12 and the inner axis layer 11 may also be formed in an integrated manner by molding and sintering to facilitate production.

To make the index wheel 10 more versatile to meet user's requirements and preference the graphic notation zone 121 on the operation layer 12 may be formed by glazing or enameling to produce different colors and graphics to overcome the monotonous look of the conventional index wheel. In addition, the graphic notation zone 121 may also be covered by a graphic layer or text printing layer. The graphics or texts may also be formed on the graphic notation zone 121 by laser engraving. The aforesaid techniques of forming the graphic notation zone 121 may also be combined, such as first forming the graphics or texts on the graphic notation zone 121, then coating a layer of a desired color or protection by glazing to enhance overall appeal.

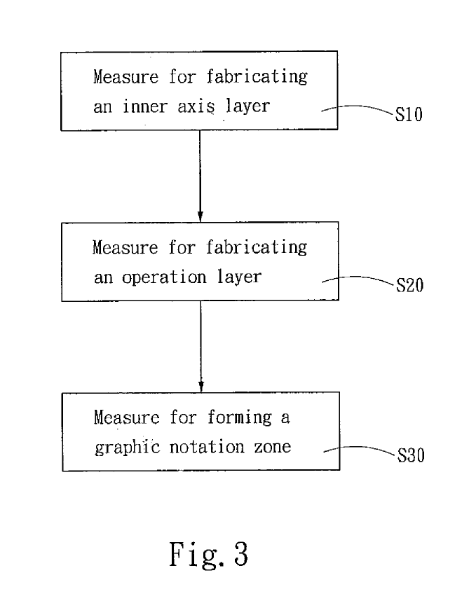

The present invention also provides a method to manufacture the index wheel 10. Refer to FIG. 3 for the manufacturing procedures:
a. measure for fabricating an inner axis layer 11 (S10);
b. measure for fabricating an operation layer 12 (S20): forming the operation layer 12 on an outer side of the inner axis layer 11 by integrated molding and sintering; and
c. measure for forming a graphic notation zone 121 on the surface of the operation layer 12 (S30).

The graphic notation zone 121 is formed on the surface of the operation layer 12 by glazing, or by printing graphics or texts or laser engraving to produce graphics or texts on the surface of the operation layer 12.

A process embodiment for manufacturing the index wheel 10 is discussed as follow:

First, form the inner axis layer 11 from plastic or ceramic materials; next, form the operation layer 12 on the outer side of the inner axis layer 11 by molding or injection or the like. The method mentioned is merely an embodiment example, not the limitation of the invention. The operation layer 12 thus formed is only a green ware without sufficient hardness. Hence the next step is to treat the green ware of the operation layer 12 in a sintering process at a selected temperature. After the sintering process is finished, the inner diameter of the operation layer 12 mates the outer diameter of the inner axis layer 11. Finally treat the operation layer 12 through the processes of glazing, printing, drawing or laser engraving to form the graphic notation zone 121.

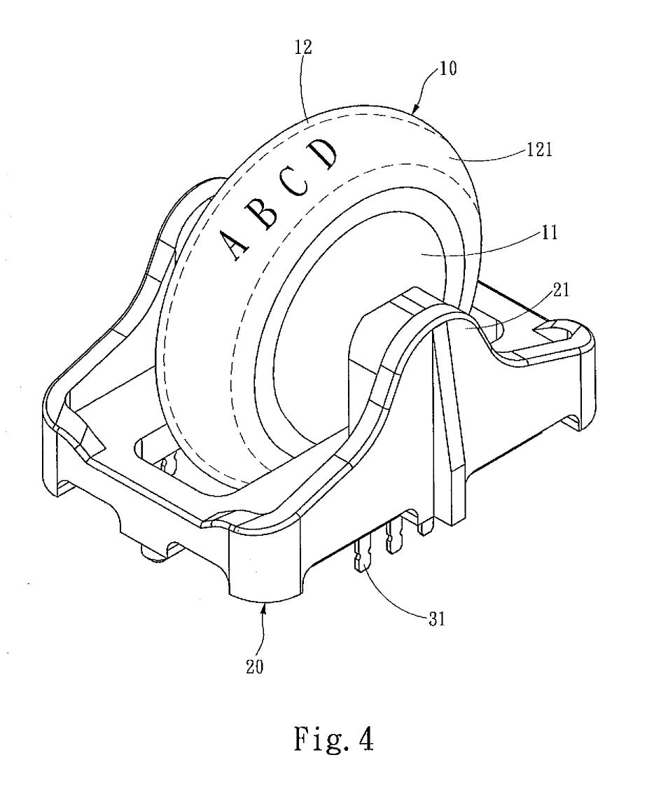

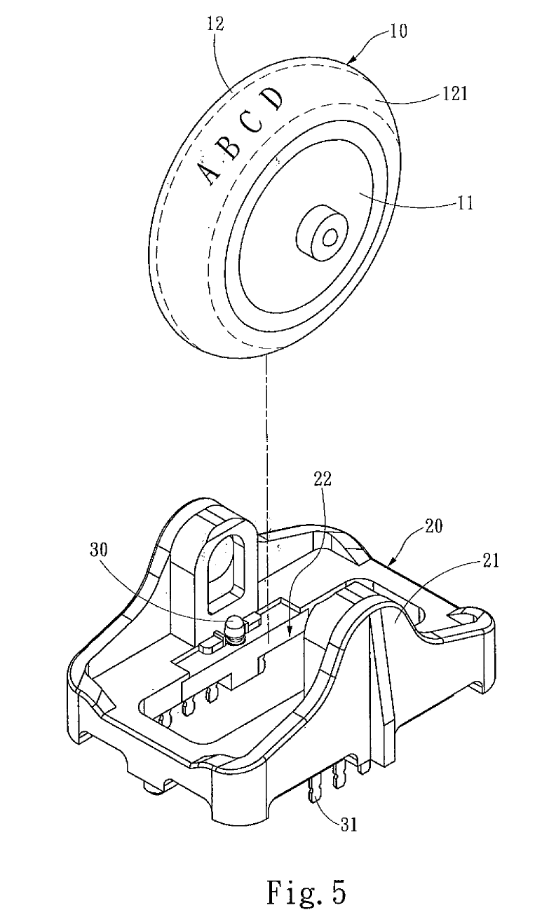

To facilitate further explanation of the invention, an embodiment of adopting the index wheel 10 of the invention to a roller module is discussed as follow. Refer to FIGS. 4 and 5, the roller module includes at least a holding dock 20, an index wheel 10 and a displacement detection unit 30 located in the holding dock 20. The holding dock 20 has at lease two support portions 21 to form an operation space 22 between them. The index wheel 10 is located in the operation space 22. The inner axis layer 11 is mounted onto the support portions 21. The displacement detection unit 30 is located in the holding dock 20 corresponding to the index wheel 10. At least one pin 31 is provided to output displacement signals. When the inner axis layer 11 is moved and the displacement detection unit 30 is driven, a displacement signal of the index wheel 10 is generated and output through the pin 31. The operation layer 12 of the index wheel 10 has texts or graphics formed on the graphic notation zone 121 by glazing, printing, drawing, or laser engraving so that the profile of the index wheel 10 is more versatile. In summary, the roller module equipped with the index wheel 10, due to existing of the graphic notation zone 121 on the index wheel 10, allows the index wheel 10 to adopt a versatile design in terms of the profile. Thus it has a greater appeal than the conventional roller module.

As a conclusion, the index wheel 10 of the invention has the ceramic operation layer 12 formed with the graphic notation zone 121 containing graphics or texts to become more versatile. As a result, it can be formed in a wide variety of profiles to suit different requirements and preference of users to overcome the monotonous look of the conventional index wheels. It offers a significant improvement over the conventional techniques.

While the preferred embodiments of the invention have been set forth for the purpose of disclosure, modifications of the disclosed embodiments of the invention as well as other embodiments thereof may occur to those skilled in the art. Accordingly, the appended claims are intended to cover all embodiments which do not depart from the spirit and scope of the invention.

What is claimed is:

1. An index wheel having notations installed on an electronic device to be freely rotated to generate signal command output, comprising at least an inner axis layer and an operation layer encasing the inner axis layer in a coaxial manner and movable together at the same time, the operation layer being made from a ceramic material and formed integrally by molding and sintering and having a graphic notation zone formed on the surface thereof.

2. The index wheel of claim 1, wherein the inner axis layer and the operation layer are integrally formed by sintering.

3. The index wheel of claim 1, wherein the ceramic material is selected from the group consisting of oxides, carbides, boronic compounds, nitrides or combinations thereof.

4. The index wheel of claim 3, wherein the oxides are selected from the group consisting of Al₂O₃, SiO₂, ZrO₂, TiO₂ and combinations thereof.

5. The index wheel of claim 1, wherein the graphic notation zone is a layer formed by glazing.

6. The index wheel of claim 1, wherein the graphic notation zone is formed by printing a graphic or text layer.

7. The index wheel of claim 1, wherein the graphic notation zone is formed by coating a graphic or text layer.

8. The index wheel of claim 1, wherein the graphic notation zone is a graphic or text layer formed by laser engraving.

9. A method for manufacturing the index wheel as claim 1, comprising the steps of:
fabricating the inner axis layer;
fabricating the operation layer from a ceramic material on an outer side of the inner axis layer by integrated molding and sintering; and
forming the graphic notation zone on the surface of the operation layer.

10. The method of claim 9, wherein the graphic notation zone is formed on the surface of the operation layer by glazing.

11. The method of claim 9, wherein the graphic notation zone is formed on the surface of the operation layer by printing graphics or texts.

12. The method of claim 9, wherein the graphic notation zone is formed on the surface of the operation layer by coating graphics or texts.

13. The method of claim 9, wherein the graphic notation zone is formed on the surface of the operation layer by laser engraving.
